(19) United States
(12) Patent Application Publication
(10) Pub. No.: US 2026/0306884 A1
(43) Pub. Date: Oct. 8, 2026

(54) ROPING HARNESS

(71) Applicant: ZEDEL, Crolles (FR)

(72) Inventor: Noé BRASSEUR, Chambéry (FR)

(73) Assignee: ZEDEL, Crolles (FR)

(21) Appl. No.: 19/642,197

(22) Filed: Apr. 8, 2026

(30) Foreign Application Priority Data
Apr. 8, 2025 (FR) 2503746

(51) Int. Cl. A62B 35/00

(52) U.S. Cl. CPC A62B 35/0018; A62B 35/0025

(57) ABSTRACT

A roping harness is equipped with a first leg loop, a second leg loop, a first shoulder strap, and a second shoulder strap. A mechanical link connects a dorsal portion of the first shoulder strap and a dorsal portion of the second shoulder strap to the first leg loop and to the second leg loop. The mechanical link comprises a connector attached to the dorsal portion of the first shoulder strap and attached to the dorsal portion of the second shoulder strap and a dorsal link having a first end attached to the first leg loop and a second end attached to the second leg loop. The dorsal link passes through the connector and is capable of sliding freely relative to the connector between the first end and the second end.

### TECHNICAL FIELD

The invention relates to a roping harness.

### STATE OF THE ART

In the field of rope access work, rope access technicians wear harnesses equipped with shoulder straps. These harnesses are generally heavier than their strapless counterparts, but they provide improved comfort.

Depending on needs, different configurations of roping harnesses equipped with shoulder straps exist. The rope access technician will preferentially choose one configuration or another depending on whether they are mostly suspended in their harness or supported by their legs, and whether they need one or more dorsal and/or frontal suspension points. The user chooses their roping harness based on the movements that will be performed regularly, i.e., according to the ability of the harness to accept certain movements of the user.

When there is a need for easier donning of the roping harness, one seeks to remove the waist belt or uses a roping harness with an openable waist belt. In a roping harness devoid of a waist belt, in order to provide optimal resistance to forces, particularly during falls, the leg loops are mechanically linked to the shoulder straps. One or more straps are linked together to form a leg loop, and the straps extend to form a shoulder strap. Typically, one or more straps form the right shoulder strap and the left leg loop, while one or more other straps form the left shoulder strap and the right leg loop.

The sets of straps are crossed in the back of the roping harness, which allows for the definition of a dorsal suspension point. Various embodiments can be observed in documents US5531292, US6253874, US6467851, US20050067221A1, US20080060873A1, US20100200329A1, US20110017546A1, US2020011481A1. In these embodiments, the two straps that cross in the back of the user may be sewn together, they may pass through a slot, or they may be linked by a linking element that fixes the position of the two straps while allowing or prohibiting sliding of the strap relative to the linking element.

Document US 10,137,322 discloses a roping harness equipped with one strap or several straps that are associated with each other to define two shoulder straps and two leg loops. The two shoulder straps pass over the shoulders of the user while the two leg loops go around each of the thighs. The harness also comprises a waist belt that goes around the abdomen of the user. A weight distribution assembly is used which attaches on one hand to the waist belt and which attaches on the other hand to the two shoulder straps. A rod allows for fixing the distance between the dorsal part of the waist belt and the dorsal suspension point that attaches to the shoulder straps. It appears that in configurations where the rope access technician must contort themselves to progress along scaffolding or in a machine, this configuration is not suitable

### DISCLOSURE OF THE INVENTION

An object of the invention consists of providing a roping harness equipped with shoulder straps and leg loops and which allows for greater freedom of movement at the bust level, and particularly during asymmetrical movements.

These disadvantages tend to be resolved by means of a roping harness possessing:

a lower part possessing a first leg loop, a second leg loop, and optionally a waist belt;

an upper part possessing a first shoulder strap and a second shoulder strap;

a dorsal connection linking a dorsal portion of the lower part with a dorsal portion of the upper part, the dorsal connection possessing a connector and a dorsal link, the dorsal link passing through the connector and being capable of sliding freely relative to the connector between a first end of the dorsal link and a second end of the dorsal link; wherein one of the first end of the dorsal link and the second end of the dorsal link is linked to a right part of the roping harness and the other of the first end of the dorsal link and the second end of the dorsal link is linked to a left part of the roping harness; wherein when the connector is attached to the upper part, the first end and the second end are attached to the lower part, and wherein when the connector is attached to the lower part, the first end and the second end are attached to the upper part.

According to an advantageous aspect of the invention, the connector possesses a first elementary connector attached to the dorsal portion of the first shoulder strap and to the dorsal portion of the second shoulder strap. The first elementary connector defines a slot through which the dorsal link passes. The first end and the second end are attached to the dorsal portion of the lower part, the first end and the second end being separated by a median sagittal plane of the roping harness.

Preferentially, the roping harness is devoid of a waist belt, the first end being fixed to the first leg loop and the second end being fixed to the second leg loop.

Advantageously, the dorsal portion of the first shoulder strap is attached to the dorsal portion of the second shoulder strap by a shoulder strap wire element. The connector is fixedly attached to the shoulder strap wire element.

Preferably, the connector possesses a dorsal attachment point intended to be fixed to an anchor point. The connector possesses a rigid part defining a slot for the passage of the dorsal link and a hole forming the dorsal attachment point.

It is advantageous to provide that the dorsal attachment point be fixedly arranged relative to the slot.

In a preferred embodiment, the dorsal attachment point is arranged movably relative to the slot.

Advantageously, the dorsal portion of the first shoulder strap and the dorsal portion of the second shoulder strap are formed by the same shoulder strap wire element attached to the connector.

In a preferred embodiment, the connector comprises a first elementary connector attached to the dorsal portion of the lower part. The first elementary connector defines a slot through which the dorsal link passes. The first end and the second end are attached to the dorsal portion of the upper part, the first end and the second end being separated by a median sagittal plane of the roping harness.

It is interesting to provide that the first end be attached directly to the dorsal portion of the first shoulder strap and that the second end be attached directly to the dorsal portion of the second shoulder strap.

In a preferred development, the roping harness comprises at least one link adjustment device configured to define an effective length of the dorsal link between the first end and the second end.

### DESCRIPTION OF THE DRAWINGS

Further advantages and features will become clearer from the following description of specific embodiments and methods of implementing the invention, which are provided as non-limiting examples and illustrated in the accompanying drawings, in which:

FIG. 1 schematically illustrates a first embodiment of a roping harness;

FIG. 2 schematically illustrates a second embodiment of a roping harness;

FIG. 3 schematically illustrates a third embodiment of a roping harness;

FIG. 4 schematically illustrates a view of a first embodiment of a dorsal connection possessing a connector with a single elementary connector attached to the dorsal portions of shoulder straps and a dorsal link passing through the elementary connector;

FIG. 5 schematically illustrates a view of the first embodiment of a dorsal connection whose connector is devoid of a dorsal attachment point;

FIG. 6 schematically illustrates a view of a second embodiment of a dorsal connection possessing a connector with a single elementary connector attached to the dorsal portions of shoulder straps and a dorsal link passing through the elementary connector, the elementary connector being deformable between the hooking to the shoulder straps and the passage slot of the dorsal link;

FIG. 7 schematically illustrates a view of the second embodiment of a dorsal connection whose connector is devoid of a dorsal attachment point ;

FIG. 8 schematically illustrates a view of a third embodiment of a dorsal connection possessing a connector with a single elementary connector attached to the dorsal portions of shoulder straps and a dorsal link passing through the elementary connector, the elementary connector possessing a dorsal attachment point higher than the hooking to the shoulder straps;

FIG. 9 schematically illustrates a view of a fourth embodiment of a dorsal connection possessing a connector with a single elementary connector attached to the dorsal portions of shoulder straps and a dorsal link passing through the elementary connector, the elementary connector being deformable between the hooking to the shoulder straps and the passage slot of the dorsal link and possessing a dorsal attachment point higher than the hooking to the shoulder straps;

FIG. 10 schematically illustrates a view of a fifth embodiment of a connector equipped with a single elementary connector attached to a waist belt and a dorsal link passing through the elementary connector;

FIG. 11 schematically illustrates a view of a sixth embodiment of a connector equipped with two elementary connectors attached to a waist belt and a dorsal link passing through each of the two elementary connectors;

FIG. 12 schematically illustrates a view of a seventh embodiment of a connector equipped with a first and a second elementary connector attached respectively to a first and a second shoulder strap and a dorsal link passing through each of the two elementary connectors;

FIG. 13 schematically illustrates a view of an eighth embodiment of a connector equipped with a first and a second elementary connector attached respectively to a first and a second shoulder strap and a dorsal link passing through each of the two elementary connectors, the strands of the dorsal link crossing;

FIG. 14 schematically illustrates a view of a ninth embodiment of a connector equipped with a first and a second elementary connector attached respectively to a first and a second leg loop and a dorsal link attaching to each of the shoulder straps and passing through each of the two elementary connectors;

FIG. 15 schematically illustrates a view of a tenth embodiment of a connector equipped with a first and a second elementary connector attached respectively to a first and a second shoulder strap and a dorsal link attaching to each of the leg loops and passing through each of the two elementary connectors;

FIG. 16 schematically illustrates a cross-sectional view of a first embodiment of a connector linking the shoulder straps and a dorsal link;

FIG. 17 schematically illustrates a cross-sectional view of a second embodiment of a connector linking the shoulder straps and a dorsal link.

### DETAILED DESCRIPTION

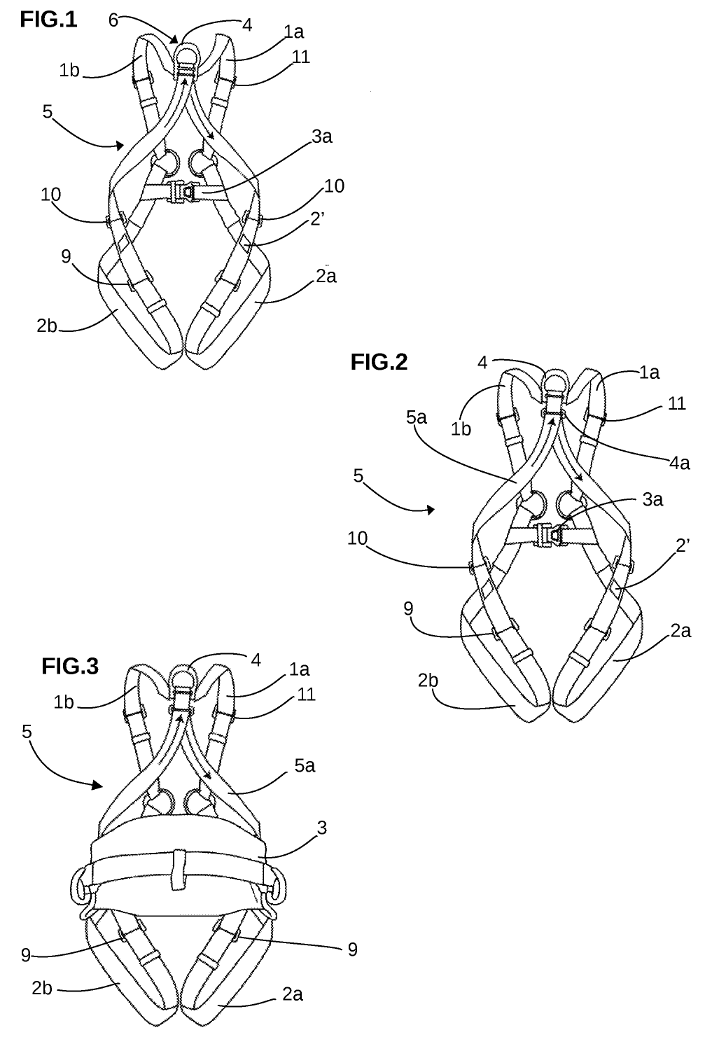

As illustrated in FIGS. 1, 2, and 3, the roping harness possesses a first shoulder strap 1a, a second shoulder strap 1b, a first leg loop 2a, and a second leg loop 2b. The first shoulder strap 1a and the second shoulder strap 1b each possess a dorsal portion and a frontal portion. The dorsal portion is intended to come facing the back of the user while the frontal portion is intended to come facing the front side of the user. The frontal portion and the dorsal portion are separated by the median frontal plane of the user. The first shoulder strap 1a and the second shoulder strap 1b can independently be of fixed length or adjustable length.

The first leg loop 2a and the second leg loop 2b each go around one of the thighs of the user. The first leg loop 2a and the second leg loop 2b can independently be of fixed circumference or adjustable circumference.

Each of the first shoulder strap 1a and the second shoulder strap 1b can be formed by one or more wire elements. The wire elements can be chosen from a woven material, a braided material, or a knitted material. It is advantageous for the wire elements to be a strap or a fabric.

Each of the first leg loop 2a and the second leg loop 2b can be formed by one or more wire elements. The wire elements can be chosen from a woven material, a braided material, or a knitted material. It is advantageous for the wire elements to be a strap or a fabric.

FIG. 3 illustrates a roping harness equipped with a waist belt 3 whereas FIGS. 1 and 2 illustrate a roping harness devoid of a waist belt 3.

The roping harness possesses an upper part intended to receive the shoulders and a lower part intended to receive the thighs of the user. The upper part and the lower part are mechanically linked so that a suspension force applied to the upper part can be taken up at least in part by the thighs of the user by means of the leg loops. The upper part possesses the first shoulder strap 1a and the second shoulder strap 1b. The lower part possesses the first leg loop 2a, the second leg loop 2b, and preferentially the waist belt 3 where applicable. The waist belt 3 is preferentially intended to come into contact with the hips of the user.

In the embodiment illustrated in FIGS. 1 and 2, the first shoulder strap 1a and the first leg loop 2a are attached together to form a first lateral part of the roping harness, for example the right part. The second shoulder strap 1b and the second leg loop 2b are attached together to form a second lateral part of the roping harness, for example the left part. The right part and the left part are separated by a median sagittal plane.

The first lateral part and the second lateral part are attached together to ensure mechanical continuity between the right part and the left part of the roping harness.

When the roping harness is equipped with a waist belt 3, the first shoulder strap 1a and the second shoulder strap 1b can be fixed together or independently to the waist belt 3. The first leg loop 2a and the second leg loop 2b can be fixed to the waist belt 3.

In the particular embodiment illustrated in FIGS. 1 and 2, the dorsal portion of the first shoulder strap 1a is linked to the dorsal portion of the second shoulder strap 1b by a shoulder strap wire element 1'. Advantageously, the dorsal portion of the first shoulder strap 1a and the dorsal portion of the second shoulder strap 1b are formed by the same wire element or by a group of wire elements that are fixed to one another. The shoulder strap wire element is preferentially a strap. The frontal portion of the first shoulder strap 1a and the frontal portion of the second shoulder strap 1b preferentially comprise different wire elements. It is advantageous that the dorsal portion of the first shoulder strap 1a and the dorsal portion of the second shoulder strap 1b be devoid of adjustment means intended to adjust the length of the shoulder straps.

It is advantageous that the first shoulder strap 1a and the second shoulder strap 1b each be equipped with a shoulder strap adjustment device configured to adjust the effective length of the shoulder strap. The shoulder strap adjustment device is preferentially arranged in the front part of the shoulder strap in order to facilitate adjustments.

In the particular embodiment illustrated in FIGS. 1 and 2, the roping harness is a full front-opening harness, i.e., it is devoid of an assembly of wire elements that goes completely around the user in a transverse or axial plane and which is not openable. Preferentially, the roping harness is devoid of a waist belt 3, i.e., devoid of a strength element that extends continuously to go around the user in a transverse plane. The embodiments illustrated in FIGS. 1 and 2 are devoid of a waist belt.

It is particularly advantageous to have a roping harness that is entirely openable between its right part and its left part as this facilitates donning the roping harness or its removal. The absence of a waist belt allows for limiting the weight of the roping harness. The right part is equipped with a right shoulder strap and a right leg loop while the left part is equipped with a left shoulder strap and a left leg loop. The right part and the left part are mechanically linked to each other in the dorsal portion of the roping harness. Preferentially, the frontal portion of the first shoulder strap 1a is not directly connected to the frontal portion of the second shoulder strap 1b or they may present a configuration that allows relative displacement between the shoulder straps. In the embodiment illustrated in FIGS. 1 and 2, the right shoulder strap possesses a right hooking point and the left shoulder strap possesses a left hooking point. The right hooking point and the left hooking point are intended to be attached to the same connector in order to form a frontal hooking point which will apply forces to the right lateral part and to the left lateral part. Such a configuration is particularly advantageous when the user is not intended to be suspended or suspended for a long time in the roping harness.

In an advantageous embodiment, the roping harness illustrated in FIGS. 1 and 2 is equipped with an opening/closing device 3a which possesses a first end fixed to the frontal portion of the first shoulder strap 1a and a second end fixed to the frontal portion of the second shoulder strap 1b. The opening/closing device 3 possesses a buckle which presents an open position where the first end is dissociated from the second end and a closed position where the first end is mechanically linked to the second end. In the closed position, the opening/closing device 3 allows for maintaining the harness in a closed position, i.e., in a position that prevents separation between the roping harness and the user wearing the roping harness.

When the roping harness is equipped with a waist belt 3, the waist belt 3 can be closed by the opening/closing device in order to facilitate donning and removal of the roping harness.

To improve the ergonomics of the roping harness, a roping harness is proposed in which the dorsal portion of the lower part and the dorsal portion of the upper part are linked by a dorsal connection. The dorsal connection is a mechanical connection that ensures the transfer of force between the lower part and the upper part when the harness is suspended by its upper part or its lower part. The dorsal connection is a mechanical connection allowing for modulating the length between the right part and the left part. This allows, for example, for adjusting the tension applied to the first shoulder strap 1a and the tension applied to the second shoulder strap 1b. The modulation of the mechanical tension is obtained by modulating the length of the connection between the right part and the left part, which allows for a pivoting of the upper body toward the right side or the left side. This frequently happens when the user seeks to reach a hold or equipment that is only accessible with a full extension of the arm and by trying to raise their shoulder as much as possible.

The dorsal connection possesses a connector 4 and a dorsal link 5. The dorsal link 5 passes through the connector 4 and is capable of sliding freely relative to the connector 4 between a first end of the dorsal link 5 and a second end of the dorsal link 5. Preferentially, the connector 4 is only attached to the upper part or to the lower part. When the connector 4 is attached to the upper part, the first end and the second end of the dorsal link 5 are attached to the lower part. Conversely, when the connector 4 is attached to the lower part, the first end and the second end of the dorsal link 5 are attached to the upper part. The dorsal link 5 extends from the upper part to the lower part to ensure mechanical continuity. The dorsal link 5 possesses a connection with the right part and a connection with the left part. The sliding of the dorsal link 5 relative to the connector 4 is located between the connection with the right part and the connection with the left part. The connection can be a fixed mounting or a deflection point. When the right part moves relative to the left part, the dorsal link slides relative to the connector 4.

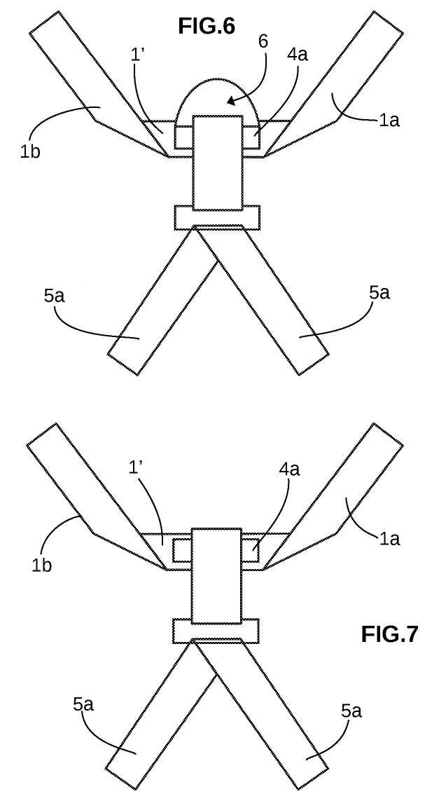

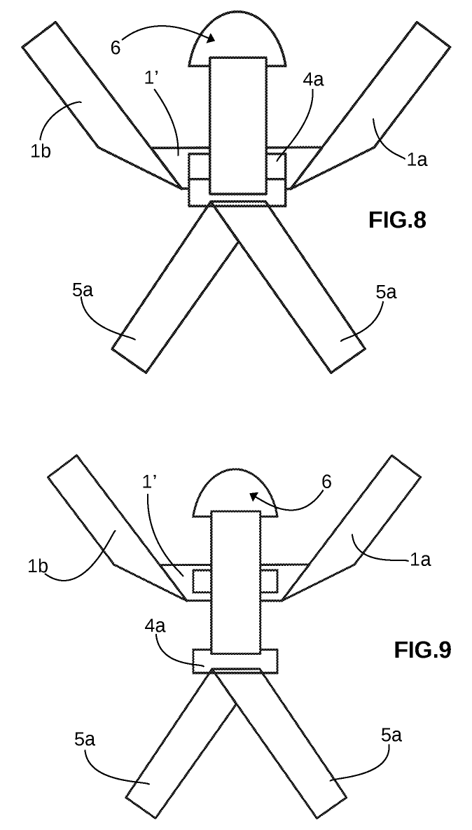

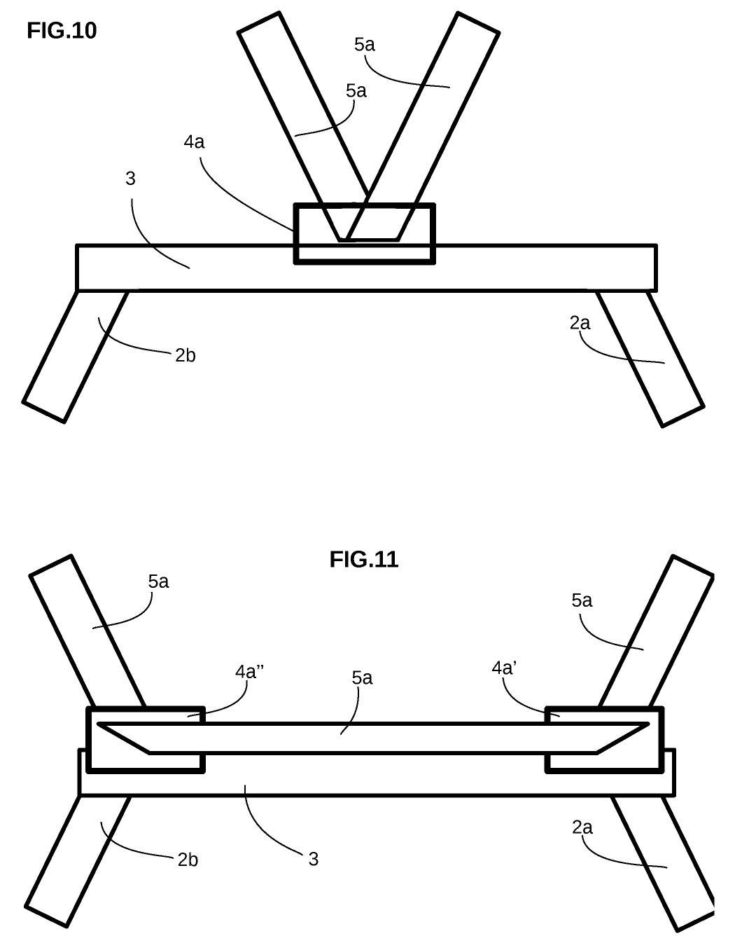

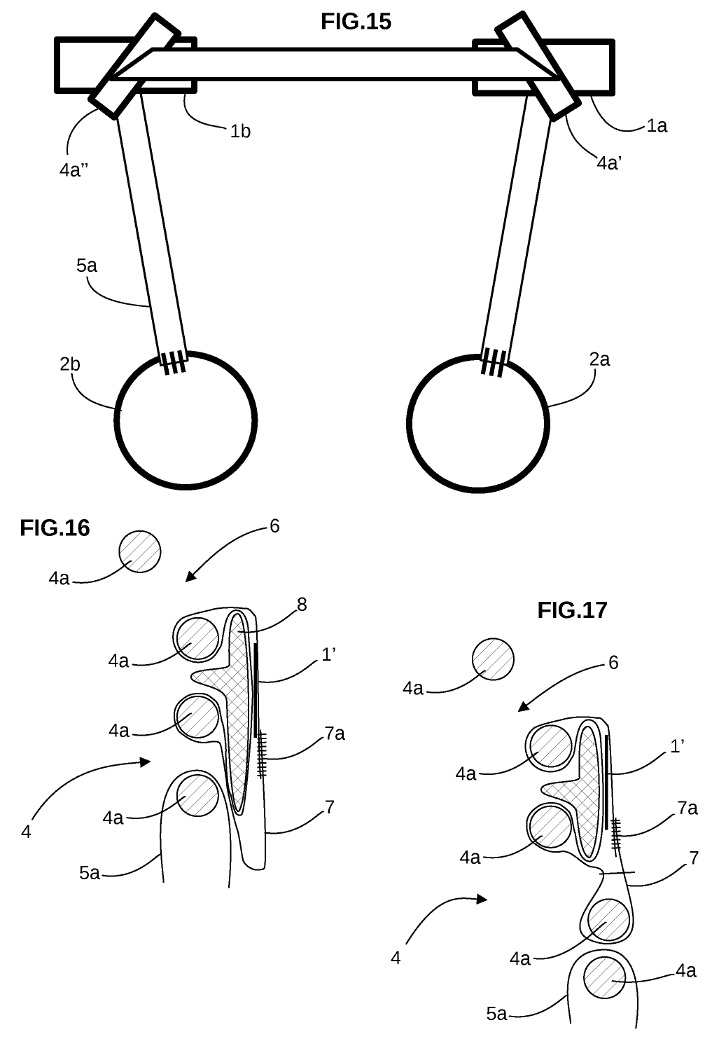

Connecting the first end and the second end on the right side and the left side with the possibility of sliding along the connector allows for having a dorsal link 5 whose length can adapt to better follow the deformation of the back relative to the pelvis. FIGS. 1, 2, 3, 4, 5, 6, 7, 8, 9, 12, 13, 15, 16, and 17 illustrate a connector attached to the upper part while FIGS. 10, 11, and 14 illustrate a connector attached to the lower part.

The dorsal connection can be completed by a frontal connection that links the shoulder straps to the leg loops and/or to the waist belt 3 and which extends along the frontal portion of the user. FIGS. 1, 2, and 3 illustrate the frontal connection.

In the embodiment illustrated in FIGS. 1 and 2, the dorsal portion of the first shoulder strap 1a and the dorsal portion of the second shoulder strap 1b are mechanically connected to the first leg loop 2a and to the second leg loop 2b by the dorsal connection. The dorsal connection possesses a connector 4 attached to the dorsal portion of the first shoulder strap 1a and to the dorsal portion of the second shoulder strap 1b and a dorsal link 5 that extends from the first leg loop 2a to the connector 4 and from the second leg loop 2b to the connector 4. The dorsal link 5 possesses a link wire element 5a which possesses a first end attached to the first leg loop 2a, a second end attached to the second leg loop 2b, and which slides inside a slot of the connector 4. The connector 4 is installed between the first end and the second end of the link wire element 5a. The link wire element 5a is able to slide along the connector 4. The connector 4 can comprise a single part or several parts.

The distance between the first end and the second end of the link wire element 5a defines the length of the dorsal link 5. It is possible to have one or more link adjustment devices 10 that are installed in the dorsal link 5 to adjust the distance between the first end and the second end of the link wire element 5a. When the user is suspended in the roping harness, the user presses on the two leg loops. The length of the wire element is substantially identical between the right part and the left part.

The sliding of the link wire element 5a relative to the connector 4 allows for increasing the distance between the connector 4 and the first end, i.e., the distance between the connector 4 and the first leg loop 2a or the waist belt 3 while reducing the distance between the connector 4 and the second end, i.e., the distance between the connector 4 and the second leg loop 2b or the waist belt 3.

The relative displacement between the link wire element 5a and the at least one connector 4 allows for better adapting the conformation of the dorsal link 5 to the posture of the user while maintaining a mechanical connection between the shoulder straps and the leg loops which is capable of supporting suspension forces, particularly during a fall. For example, when the legs and arms move in extension, particularly in a position where the user seeks maximum extension, this generally corresponds to the right arm seeking a high hold, the right leg being raised and/or flexed with support on the left leg. The reverse configuration between the right and left sides is possible. Raising the right leg allows for increasing the distance of the dorsal link between the left leg and the upper part of the right shoulder strap. The harness does not oppose the right arm seeking a high hold. As the distance between the connector 4 and one of the leg loops can increase, the dorsal link 5 does not form an obstacle to a movement of the user seeking to extend.

The distance between the connector 4 and the sacrum of the user almost does not move, which allows for not modifying too much the behavior of the roping harness in the event of a fall.

In a particular embodiment, the dorsal link 5 is attached to the first shoulder strap 1a and to the second shoulder strap 1b by means of a connector 4 possessing one or more elementary connectors 4a. In the embodiment illustrated in FIGS. 1 and 2, a single elementary connector 4a is used which is fixed to the first shoulder strap 1a and to the second shoulder strap 1b or which is free to move along the dorsal parts of the first shoulder strap 1a and the second shoulder strap 1b. Preferentially, the connector 4 defines a passage for the link wire element 5a, for example in the form of a slot. The link wire element 5a is able to slide inside the slot. The link wire element 5a goes around the connector 4 by forming a fold.

The connector 4 can be fixedly attached to the first shoulder strap 1a and to the second shoulder strap 1b or it can move along the shoulder strap wire element or the wire elements that link the two shoulder straps.

FIG. 3 illustrates a configuration where the two ends of the dorsal link 5 are attached to the waist belt 3. The dorsal link 5 passes through a single elementary connector 4a which is attached to the two shoulder straps. The two leg loops are attached to the waist belt 3.

In the particular configuration illustrated in FIGS. 1, 2, 3, 4, 5, 6, 7, 8, and 9, the dorsal portion of the first shoulder strap 1a and the dorsal portion of the second shoulder strap 1b can be fixedly connected to each other. For example, a shoulder strap wire element 1' forms all or part of the dorsal portion of the first shoulder strap 1a and it extends continuously to form all or part of the dorsal portion of the second shoulder strap 1b. Alternatively, several wire elements are fixed to each other to form all or part of the dorsal portion of the first shoulder strap 1a and all or part of the dorsal portion of the second shoulder strap 1b. It is also possible that the dorsal portion of the first shoulder strap 1a and the dorsal portion of the second shoulder strap 1b attach independently to the elementary connector 4a.

In another embodiment illustrated in FIGS. 10, 11, and 14, the connector 4 is attached to the lower part of the roping harness. It is advantageous that the roping harness be equipped with a waist belt 3 and that the connector 4 be attached to the waist belt 3. Preferentially, the first strand of the link wire element 5a attaches to the dorsal portion of the first shoulder strap 1a and the second strand of the link wire element 5a attaches to the dorsal portion of the second shoulder strap 1b. The displacement of the first shoulder strap 1a relative to the second shoulder strap 1b modifies the length of the first strand relative to the second strand by sliding relative to the connector 4.

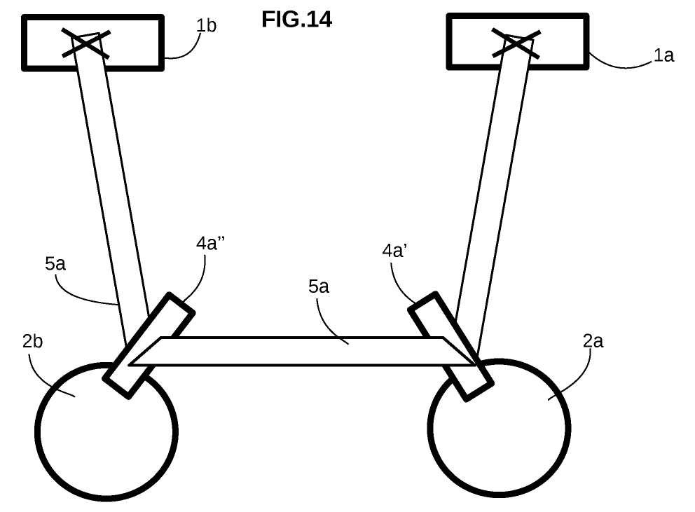

It is also possible to have an embodiment with two elementary connectors 4a which are attached to the waist belt 3 as illustrated in FIG. 11 or to have a first elementary connector 4a' which is attached to the first leg loop 2a and a second elementary connector 4a'' which is attached to the second leg loop 2b as illustrated in FIG. 14. This embodiment is less advantageous than the previous one because the connection formed between the two leg loops by the link wire element 5a can make the roping harness less practical to use. The force applied in the dorsal link 5 tends to bring the two elementary connectors closer together which can generate points of discomfort.

When the roping harness possesses a single elementary connector 4a, it is advantageous that the elementary connector 4a be arranged in the median sagittal plane of the roping harness which corresponds to the median sagittal plane of the user. This configuration allows for having a substantially similar operation for an extension on the right side and an extension on the left side. It also allows for reducing discomfort.

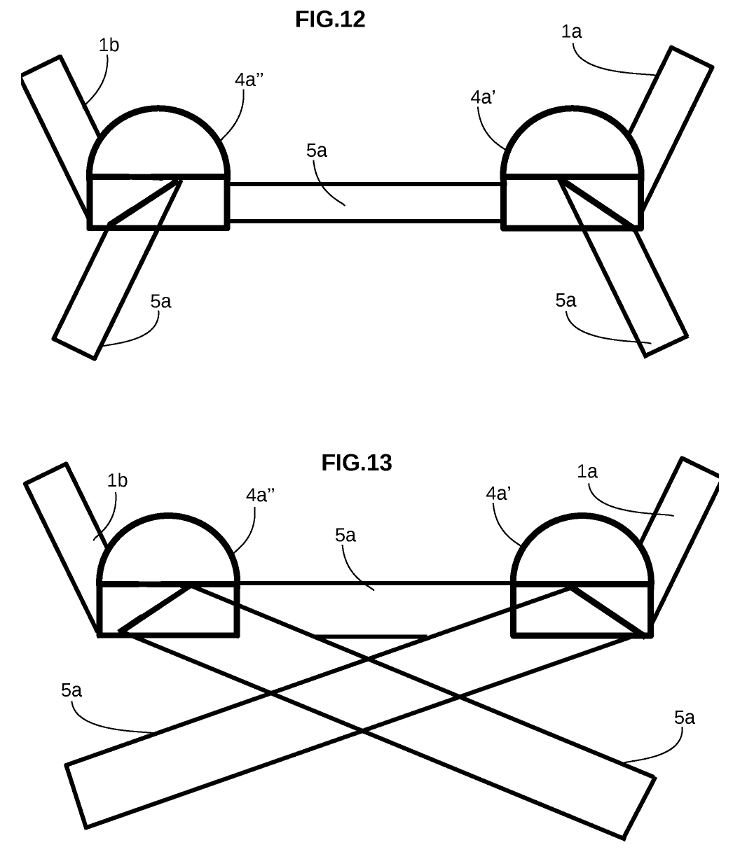

In another embodiment illustrated in FIGS. 12 to 15, the roping harness possesses two elementary connectors 4a. The two elementary connectors 4a are arranged one behind the other along the link wire element 5a between the first end and the second end. It is preferable that the first elementary connector 4a' be attached to the first shoulder strap 1a and that the second elementary connector 4a'' be attached to the second shoulder strap 1b. The link wire element 5a passes through the first elementary connector 4a' and the second elementary connector 4a''. The link wire element 5a slides inside the first elementary connector 4a' and the second elementary connector 4a''. As for the embodiment illustrated in the other figures, the sliding of the link wire element 5a allows for modifying the distance between the leg loops and the dorsal portions of the shoulder straps. It is advantageous that the two elementary connectors 4a be movable relative to each other in order to better follow the movements of the shoulder straps. However, this embodiment is less interesting than the embodiment illustrated in FIGS. 1 to 3 because when the user is suspended in the roping harness, the force applied in the link wire element 5a tends to bring the two shoulder straps closer to each other which can be uncomfortable.

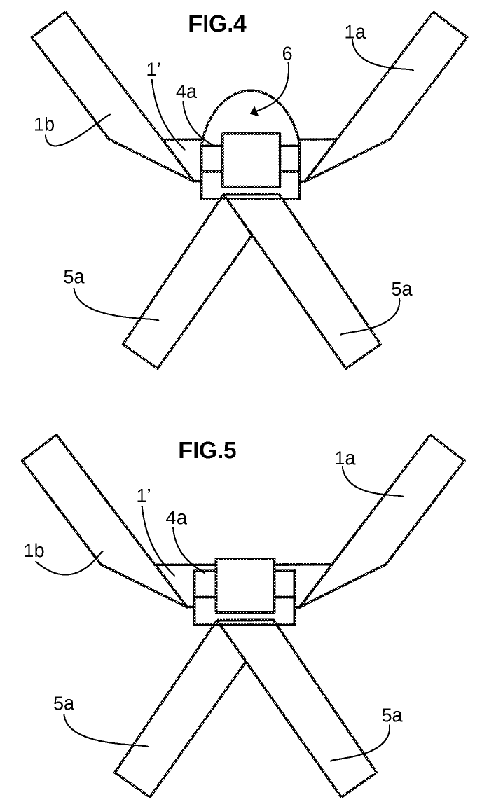

In a particular embodiment illustrated in FIGS. 1, 2, 3, 4, 6, 8, 9, 12, 13, 16, and 17, the connector 4 forms a dorsal attachment point 6 for the roping harness. The dorsal attachment point 6 is configured to support a user installed in the roping harness and suspended above the ground by being held only by the dorsal attachment point 6. FIGS. 1 to 4, 6, 8, and 9 illustrate a configuration where the connector 4 formed by a single elementary connector 4a also defines a dorsal attachment point 6. In the event of a fall, the user is caught by the dorsal attachment point 6 which is fixed to the first shoulder strap 1a and to the second shoulder strap 1b. The dorsal link 5 which provides the mechanical connection between the connector 4 forming the dorsal attachment point 6 and each of the two leg loops will ensure a take-up of the forces by the leg loops. The distance between the dorsal attachment point 6 and each of the two leg loops can change in order to better distribute the forces during the fall and after the fall depending on the position taken by the user installed in the roping harness. The dorsal link 5 can move relative to the connector 4 in order to better distribute the forces. FIGS. 4 to 7 illustrate similar configurations of mechanical connections provided with or without a dorsal attachment point 6.

FIG. 16 represents, in cross-section, the configuration of the connector 4 as well as its installation relative to a wire element linking the dorsal portion of the first shoulder strap 1a and the dorsal portion of the second shoulder strap 1b. The connector 4 possesses an elementary connector 4a which can be in the form of a rigid part, preferentially a metallic part. The elementary connector 4a defines a slot for the passage of the link wire element 5a.

The elementary connector 4 is attached to the shoulder strap wire element 1' by means of a connection loop 7. The connection loop 7 is formed by a connection wire element which attaches to the elementary connector 4a. In the specific configuration illustrated, the connection wire element is folded back on itself and closed to define a ring. One or more rods of the elementary connector 4a pass through the ring so that the ring is attached to the elementary connector 4a and more preferentially so that the ring is irremovable from the elementary connector 4a. The shoulder strap wire element 1' passes through the ring or is installed between the ring and the elementary connector 4a so that the shoulder strap wire element 1' is attached to the elementary connector 4a and preferentially attached in an irremovable manner.

In the configuration illustrated in FIGS. 16 and 17, an optional spacer 8 is installed between the elementary connector 4a and the shoulder strap wire element 1' in order to reduce friction against the shoulder strap wire element 1'. The spacer 8 is arranged inside the volume defined by the ring and which receives the shoulder strap wire element 1'. The spacer 8 preferentially extends over a height greater than the height of the shoulder strap wire element 1' to facilitate displacements of the shoulder strap wire element 1' relative to the elementary connector 4a. The height is measured in a direction perpendicular to the direction linking the first shoulder strap 1a and the second shoulder strap 1b. When the roping harness is worn, the height is preferentially measured in a vertical direction. It is advantageous to arrange the shoulder strap wire element 1' between the connector 4 and the back of the user, more preferentially between the spacer 8 and the back of the user. In the configuration illustrated in FIG. 11, the connection loop 7 is preferentially closed by a seam 7a. FIG. 16 represents a cross-sectional view of the configuration illustrated in FIG. 1.

In the configuration illustrated in FIG. 17, the rods used for fixing the ring and the slot receiving the dorsal link 5 are mounted immovably relative to each other.

In the configuration illustrated in FIG. 17 and in FIG. 2, the elementary connector 4a is deformable. The connector 4 possesses a first rigid part which preferentially defines a dorsal attachment point 6. The elementary connector 4a also possesses a second rigid part which defines a slot that receives the dorsal link 5. The link wire element 5a slides in the slot. The connection loop 7 is attached to the first rigid part and it receives the shoulder strap wire element 1' in order to hook the elementary connector 4a to the shoulder straps. The second rigid part also passes through the connection loop 7 so that the connection loop 7 ensures the mechanical connection between the first rigid part and the second rigid part. The connection loop 7 allows for having flexibility between the first rigid part and the second rigid part while ensuring the necessary mechanical strength when the connection loop is stretched. This allows for ensuring a good transfer of forces between the shoulder straps and the leg loops. The connection loop 7 offers a lateral displacement to the right or to the left of the slot relative to the first rigid part, which allows for having the slot in a more favorable position to facilitate the sliding of the link wire element 5a.

It is advantageous that the link wire element 5a forming the dorsal link 5 be a strap. It is advantageous that the slot be rectangular. The slot can be formed by a metallic ring of substantially rectangular shape. A rectangular ring is advantageous when the dorsal link 5 is formed by a strap.

Advantageously, the first shoulder strap 1a and the second shoulder strap 1b share the same wire element and the connector 4 is attached to this wire element.

The roping harness possesses a first shoulder strap 1a and a second shoulder strap 1b which are mechanically linked by means of a common wire element or a connector 4. By common wire element, it is meant a single wire element that extends continuously to form all or part of the first shoulder strap 1a and all or part of the second shoulder strap 1b. It is also meant an assembly of at least two wire elements which are in continuity with each other to define all or part of the first shoulder strap 1a and all or part of the second shoulder strap 1b. The at least two wire elements can be attached together in an irremovable manner, for example by sewing, riveting, gluing, or any other suitable means. The at least two wire elements can be attached together by means of an adjustment device configured to adjust the effective length of the wire element. The adjustment device can comprise an adjustment buckle of one of the configurations well known to those skilled in the art.

In the preferred embodiments illustrated in FIGS. 1 and 2, several wire elements are arranged one after the other and are connected by adjustment means in order to form the first shoulder strap 1a, the second shoulder strap 1b, the first leg loop 2a, and the second leg loop 2b.

The first leg loop 2a and the second leg loop 2b can comprise a fixation zone 2', for example a seam that closes the leg loop. This allows for defining a first end and a second end for a leg loop wire element. As illustrated in FIGS. 1 and 2, it is advantageous to provide a leg loop adjustment device 9 configured to adjust the circumference of the leg loop between the first end and the second end.

The wire element that forms a leg loop preferentially extends beyond the fixation zone 2' to form all or part of the link wire element 5a.

It is advantageous that the dorsal link 5 possess a link adjustment device 10 configured to adjust the effective length of the dorsal link 5.

It is advantageous that the first shoulder strap 1a and the second shoulder strap 1b possess a frontal link adjustment device 11 configured to adjust the effective length of a frontal link between the frontal portion of the shoulder strap and a frontal portion of the waist belt or a frontal portion of the leg loop.

In the embodiments illustrated in FIGS. 1 and 2, the connector 4 moves along the first strap from the fixation with the first leg loop to the fixation with the second leg loop. The first strap is formed by a single strap or a set of straps. The first strap directly links the first leg loop with the second leg loop by passing through the slot of the connector 4. In this way, the downward displacement of the fixation point with the first leg loop results in an upward displacement of the fixation point with the second leg loop and vice versa.

In the embodiment illustrated in FIG. 3, the configuration works in the same way as before. Unlike the previous configuration, the roping harness possesses a waist belt. The waist belt is mounted slidingly along the first strap. The use of a waist belt mounted slidingly relative to the first strap allows for having a relative displacement between the fixation with the first leg loop and the waist belt which is capable of inducing a corresponding and opposite displacement between the waist belt and the fixation with the second leg loop. The use of a waist belt mounted slidingly relative to the first strap means that the position of the waist belt does not oppose the sliding between the first leg loop and the second leg loop. The prior art configurations possess a waist belt that is fixedly attached to the straps that link the leg loops and the shoulder straps. In this way, the position of the waist belt which is intended to be fixedly attached to the pelvis of the user leads to the separation between the leg loops and the upper part of the roping harness.

The mountings illustrated in FIGS. 1, 2, and 3 propose roping harnesses which are devoid of a fixed hooking point with the pelvis of the user along the link wire element 5a between the fixation with the first leg loop 2a and the fixation with the second leg loop 2b. In one case, the roping harness is devoid of a waist belt 3. In another case, the roping harness possesses a waist belt 3 which is mounted slidingly along the first strap so as to allow sliding of the first strap through the connector 4 to follow the displacements of the fixation with the first leg loop 2a and the fixation with the second leg loop 2b without moving the waist belt 3. The sliding mounting of the link wire element 5a relative to the waist belt 3 allows for taking advantage of a greater amplitude in comparison with a fixation to the waist belt 3.

The presence of a connector 4 mounted slidingly along the link wire element 5a with the connector 4 attached to the upper part and the link wire element 5a attached to each of the leg loops prevents the link wire element 5a from hindering certain movements of the user, for example when the latter is supported on one of their left or right legs and they extend their opposite arm. In this case, the user tends to raise the opposite leg. This action allows the connector 4 to slide along the link wire element 5a so that the roping harness does not oppose the effort made by the user.

In document US 2022/0040510, the strap that links the two leg loops passes through the waist belt and the dorsal attachment point. The strap is fixedly attached to the waist belt by means of stitching and/or the strap forms a loop that fixes the metallic connector intended to form the dorsal attachment point. By fixing the strap to the waist belt, the movements of the leg loops have no effect on the portion of the strap arranged above the waist belt. By forming a loop by means of the strap for the installation of the dorsal attachment point, any easy sliding of the strap is prevented.

1. Roping harness possessing:
a lower part possessing a first leg loop and a second leg loop;
an upper part possessing a first shoulder strap and a second shoulder strap;
a dorsal connection linking a dorsal portion of the lower part with a dorsal portion of the upper part, the dorsal connection possessing a connector and a dorsal link, the connector being attached to the upper part;
wherein the dorsal portion of the first shoulder strap and the dorsal portion of the second shoulder strap are mechanically connected to the first leg loop and to the second leg loop by the dorsal connection;
wherein one of the first end of the dorsal link and the second end of the dorsal link is linked to a right part of the roping harness and the other of the first end of the dorsal link and the second end of the dorsal link is linked to a left part of the roping harness;
wherein the dorsal link possesses a link wire element which extends from a first end attached to the first leg loop to a second end attached to the second leg loop and which slides inside a slot of the connector between the first end of the link wire element and the second end of the link wire element;
wherein a displacement of the first leg loop to move the first end of the link wire element away from the connector causes the link wire element to slide and brings the second end of the link wire element closer to the connector; and
wherein a displacement of the second leg loop to move the second end of the link wire element away from the connector causes the link wire element to slide and brings the first end of the link wire element closer to the connector.

2. Roping harness according to claim 1, wherein the connector possesses a first elementary connector attached to the dorsal portion of the first shoulder strap and to the dorsal portion of the second shoulder strap, wherein the first elementary connector defines a slot through which the dorsal link passes, and wherein the first end and the second end are attached to the dorsal portion of the lower part, the first end and the second end being separated by a median sagittal plane of the roping harness.

3. Roping harness according to claim 1, wherein the dorsal portion of the first shoulder strap is attached to the dorsal portion of the second shoulder strap by a shoulder strap wire element, and wherein the connector is fixedly attached to the shoulder strap wire element.

4. Roping harness according to claim 1, wherein the connector possesses a dorsal attachment point intended to be fixed to an anchor point, wherein the connector possesses a rigid part defining a slot for the passage of the dorsal link and a hole forming the dorsal attachment point.

5. Roping harness according to claim 4, wherein the dorsal attachment point is fixedly arranged relative to the slot.

6. Roping harness according to claim 4, wherein the dorsal attachment point is movably arranged relative to the slot.

7. Roping harness according to claim 1, wherein the dorsal portion of the first shoulder strap and the dorsal portion of the second shoulder strap are formed by the same shoulder strap wire element attached to the connector.

8. Roping harness according to claim 1, comprising at least one link adjustment device configured to define an effective length of the dorsal link between the first end and the second end.

9. Roping harness according to claim 1, comprising a waist belt.
